(19) United States
(12) Patent Application Publication
(10) Pub. No.: US 2011/0193964 A1
(43) Pub. Date: Aug. 11, 2011

(54) Method and System for Wireless Monitoring

(76) Inventor: Gregory F. McLeod, Atlanta, GA (US)

(21) Appl. No.: 13/022,267

(22) Filed: Feb. 7, 2011

Related U.S. Application Data
(60) Provisional application No. 61/302,152, filed on Feb. 7, 2010.

(51) Int. Cl. H04N 7/18

(52) U.S. Cl. 348/158

(57) ABSTRACT

Methods and systems for wireless audio and video monitoring are disclosed. The methods and systems for wireless audio and video monitoring incorporate portability and bi-directional features. The system components are able to identify and connect via a wireless transmission method with the greatest available bandwidth. Bluetooth, Wi-Fi, cellular networks or a combination thereof are disclosed as transmission methods. The methods and systems also include the ability to transmit the audio and video to multiple receivers simultaneously.

### CROSS-REFERENCE TO RELATED APPLICATIONS

This application claims the benefit of U.S. Patent Application No. 61/302,152, filed Feb. 7, 2010, which is incorporated herein by reference.

### BACKGROUND

1. Field of the Invention

The invention relates to a method and system for wireless audio and video monitoring. More particularly, the invention relates to a method and system for wireless audio and video monitoring that incorporates portability, bidirectional features, connects the video camera and the receivers via Bluetooth, Wi-Fi, cellular data networks, GPS or a combination thereof and in which the audio and video are transmitted to multiple receivers simultaneously.

2. General Background

Audio and video monitoring are well known, including those that offer monitoring of a baby. These systems generally include a small stationary camera and a handheld receiver for receiving the audio and video images. Such systems may include a wireless connection between the camera and the receiver. However, these currently available systems are unable to meet all the needs of the user.

For example, most video baby monitors use different frequencies to send their signals. Often, these same frequencies are used by many other common household electronics, and as a result undesirable interference can occur. The 900 MHz bandwidth has been a popular frequency for many wireless devices, including baby monitors. Devices such as cordless phones, wireless headphones, and wireless speaker systems that use this bandwidth will cause interference with a 900 MHz baby monitor. In response to this problem, manufacturers of wireless devices have turned to 2.4 GHz as a useful frequency. This has caused the 2.4 GHz band to become over crowded and prone to interference issues, as there may be several wireless devices using this frequency in the home. A growing number of monitors stream video exclusively via a Wi-Fi networked camera to a smart phone. The transmission is totally interference-free because it uses a Wi-Fi network. Additionally, users can view their baby from anywhere via a web connection. However, if the user does not have a Wi-Fi network available, a connection would be impossible. Thus, a system that is both interference-free and includes flexible connection methods between the camera and receiver is needed.

As people, including parents, become more tech savvy and share more information about their families, there is also a desire to be able to capture video and still photos of the images transmitted by the camera. Currently, known video monitoring systems allow a user to capture video and still images on a local computer connected to the system via hardwire or Wi-Fi. These systems require a user to have sufficient computer skills to capture the desired video and still images and to determine an appropriate medium (i.e., Internet websites, social networking, email) by which to share them. A simpler solution for sharing video and still photos would be beneficial for users.

Many known wireless video monitoring systems include multiple receivers, but most include only one camera. Although sophisticated security systems often include this feature and the ability to see the images from multiple cameras on one receiver, a solution for the home user is lacking. Users, particularly parents, desire the ability to view images from multiple cameras on a single receiver, or even on a smart phone. It would also be advantageous for the user to be able to easily switch between cameras.

Additionally, people have become accustomed to meeting many of their technology needs with their smart phones. Although it is known to use a smart phone as an audio monitor through the use of a dedicated application, it is less common for a wireless video monitoring system to incorporate the use of a smart phone as a receiver. Those systems that anticipate use of a smart phone as a receiver either do not allow simultaneously use of the phone for calls and monitoring or do not take measure to insure that the connection is maintained. Thus, if a user receives a call, the monitoring connection may be ended.

Commonly known wireless video monitoring systems suffer from a common problem when the object, person or baby being monitored moves out of the field of view. When setting up the camera, the user may desire to place it close to the baby so that he/she can see the baby more clearly. However, if the baby moves to a different area, the baby is now out of view. The user must enter the room being monitored and physically move the monitor. The user may set up the camera up at a greater distance from the baby, so that the entire bed is in the viewing frame. However, this renders the user unable to see the finer details of the baby's movement, such as breathing movements or open eyes.

A wireless video monitoring system that allows the user to interact and communicate with the baby or person being monitored is also desired, such as one incorporating a microphone on the receiver.

### BRIEF SUMMARY OF THE INVENTION

Embodiments of the invention provide a wireless monitoring system including (a) at least one audio and video capture device having a video camera, a microphone, a speaker, a transmitter for transmitting audio and video data, and a receiver for receiving directional input to pan, tilt or zoom; (b) at least one receiving device for receiving audio and video data, wherein the receiving device includes a screen for displaying the video data, a speaker for emitting the sound data, a microphone to transmit audio data from a user to the audio and video capture device, and communication circuitry operable to: identify and effect a wireless transmission connection with the greatest available bandwidth; transmit directional instructions to pan, tilt or zoom from the user to the audio and video capture device; and transmit instructions from the user to the audio and video capture device to save still photographs or portions of video from the video data; and (c) a mounting device for removably mounting the audio and video capture device in a location.

In some embodiments, the mounting device includes at least one ball and socket structure for positioning the audio and video capture device.

In other embodiments, the mounting device includes a tension clip. In still other embodiments, the mounting device includes a suction cup

In some embodiments, the invention includes multiple receiving devices for receiving audio and video data and the audio and video data may be received by multiple receiving devices simultaneously.

In some embodiments, the audio and video data is transmitted from the audio and video capture device to the at least one receiving device via one of the following wireless protocols: Bluetooth, Wi-Fi, and a combination of Bluetooth and Wi-Fi.

In other embodiments, the at least one receiving device is bi-direction and can control the pan, zoom and tilt of the audio and video capture device.

In still other embodiments, the at least one receiving device is a portable electronic device. In other embodiments, the at least one receiving device is a computer.

Some embodiments include infrared emitters that allow the audio and video capture device to capture images in low ambient lighting.

Embodiments of the invention include a system in which at least one receiving device receives audio and video data from multiple audio and video capture devices.

In other embodiments, the portable electronic device comprises: an input component operable to receive audio and video data from the audio and video capture device; and communication circuitry operable to: transmit audio data from a user to the audio and video capture device; transmit directional instructions to pan, tilt or zoom from the user to the audio and video capture device; and transmit instructions from the user to the audio and video capture device to save still photographs or portions of video from the video data;

In further embodiments, the portable electronic device includes circuitry to function as a cellular phone and to simultaneously maintain a cellular phone call and the wireless monitoring functions.

Embodiments of the invention include a wireless monitoring system including (a) an audio and video capture device having a video camera, a microphone, a speaker, a transmitter for transmitting audio and video data, a receiver for receiving directional input to pan, tilt or zoom, and infrared emitters that allow the audio and video capture device to capture images in low ambient lighting; (b) a mounting device for removably mounting the audio and video capture device in a location, wherein the mounting device comprises a ball and socket structure for aiming the audio and video capture device; (c) at least one receiving device for receiving audio and video data, wherein the receiving device includes a screen for displaying the video data, a speaker for emitting the sound data, a microphone to transmit audio data from a user to the audio and video capture device, and communication circuitry operable to: identify and effect a wireless transmission connection with the greatest available bandwidth; transmit directional instructions to pan, tilt or zoom from the user to the audio and video capture device; and transmit instructions from the user to the audio and video capture device to save still photographs or portions of video from the video data; (d) a portable electronic device for interfacing with the audio and video capture device, the portable electronic device comprising: an input component operable to receive audio and video data from the audio and video capture device; and communication circuitry operable to: transmit audio data from a user to the audio and video capture device; transmit directional instructions to pan, tilt or zoom from the user to the audio and video capture device; and transmit instructions from the user to the audio and video capture device to save still photographs or portions of video from the video data. The audio and video data is transmitted from the audio and video capture device to the at least one receiving device via one of the following wireless protocols: Bluetooth, Wi-Fi, and a combination of Bluetooth and Wi-Fi. The portable electronic device includes circuitry to function as a cellular phone and to simultaneously maintain a cellular phone call and the wireless monitoring functions.

Embodiments of the invention include a method for wirelessly monitoring an area. The method includes (a) providing power to an audio and video capture device; (b) searching by the audio and video capture device for a receiver to connect with; (c) identifying and selecting an available wireless protocol with the greatest bandwidth available; (d) connecting the audio and video capture device with the receiver via the available wireless protocol with the greatest bandwidth available; (e) adjusting the pan, tilt and zoom of the audio and video capture device with the receiver; and (f) receiving audio and video data on the receiver.

In other embodiments, the method further includes storing the audio and video data on a server in a remote data center; and recalling the stored audio and video data at a later time.

In other embodiments, the audio and video capture device is connected to the receiver via a server in a remote data center and further comprising the steps of (g) verifying a user's identification and password before making the remote connection; (h) receiving input from the user regarding the desired audio and video capture device from which to receive data; (i) adjusting the resolution and frame rate of the audio and video capture device to match the available bandwidth on the selected wireless connection; and (j) starting the transmission of data from the audio and video capture device to the receiver.

In still other embodiments, the method further includes (k) storing the audio and video data on a server in a remote data center; and (l) recalling the stored audio and video data at a later time.

In still other embodiments, the wireless protocol is one of the following wireless protocols: Bluetooth, Wi-Fi, and a combination of Bluetooth and Wi-Fi

Further details and embodiments of the invention are set forth below. These and other features, aspects and advantages of the invention are better understood when the following Detailed Description is read with reference to the accompanying drawings.

### BRIEF DESCRIPTION OF THE DRAWINGS

FIG. 1 is a diagram of a system for wireless audio and video monitoring according to embodiments of the invention.

FIG. 2 is perspective view of a system for wireless audio and video monitoring according to embodiments of the invention.

FIG. 3A is a front plan view of a camera according to embodiments of the invention.

FIG. 3B is side plan view of a camera according to embodiments of the invention.

FIG. 4A is a side plan view of a dedicated receiver according to embodiments of the invention.

FIG. 4B is a front plan view of a dedicated receiver according to embodiments of the invention.

FIG. 4A is a perspective view of the back of a dedicated receiver according to embodiments of the invention.

FIG. 5A is a perspective view of an audio and video capture device with a tension clip mount according to embodiments of the invention.

FIG. 5B is a side plan view of an audio and video capture device with a tension clip mount according to embodiments of the invention.

FIG. 6A is a perspective view of an audio and video capture device with a suction cup mount according to embodiments of the invention.

FIG. 6B is a side plan view of an audio and video capture device with a suction cup mount according to embodiments of the invention.

FIG. 7 is flow chart of a method of choosing a wireless connection method according to embodiments of the invention.

FIG. 8 is a flow chart of a method of using a smart phone to receive audio and video data via remote connection according to embodiments of the invention.

FIG. 9 is a flow chart of a method of using a local computer to receive audio and video data according to embodiments of the invention.

FIG. 10 is a flow chart of a method of using a smart phone to receive audio and video data via a local connection according to embodiments of the invention.

FIG. 11 is a flow chart of a method of using a dedicated receiver to receive audio and video data according to embodiments of the invention.

### DETAILED DESCRIPTION OF THE INVENTION

The invention generally relates to methods and systems for wireless audio and video monitoring. The methods and systems for wireless audio and video monitoring incorporate portability and bi-directional features; connect the audio and video camera with the receivers via Bluetooth, Wi-Fi or a combination thereof; and include the ability to transmit the audio and video to multiple receivers simultaneously.

This invention will now be described more fully with reference to the drawings, showing preferred embodiments of the invention. However, this invention can be embodied in many different forms and should not be construed as limited to the embodiments set forth.

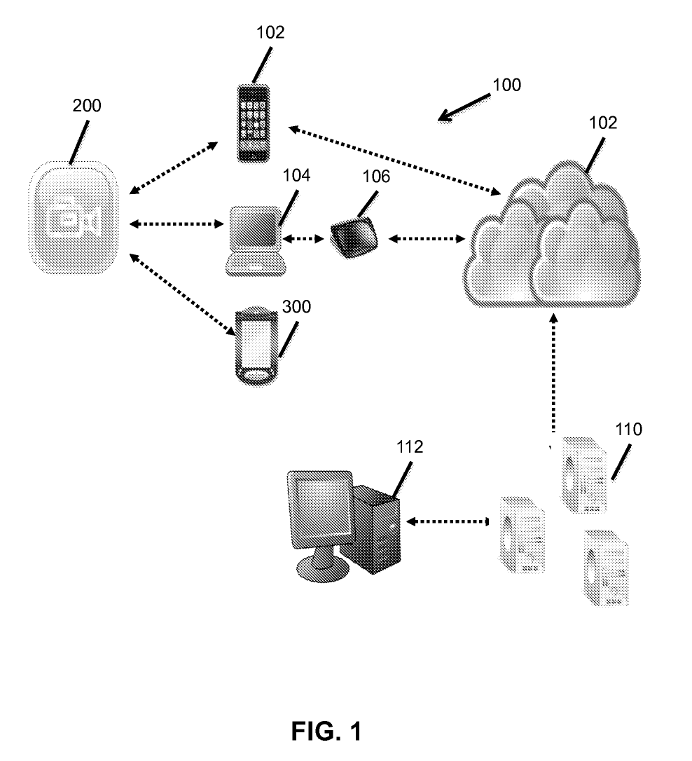

As shown in FIG. 1, embodiments of the invention include systems 100 for wireless audio and video monitoring. In some embodiments, the system 100 includes an audio and video capture device 200, a smart phone 102, a local computer 104 and a dedicated receiver 300. The local computer 104 may be connected to the Internet 108 via a router 106. In some embodiments, the system 100 further includes servers 110 at a remote data centers. The servers 110 enable a user to use a remote computer 112 to gain access the audio and video images captured by the audio and video capture device 200. In other embodiments (not shown), the system 100 may not include a smart phone 102. In still other embodiments (not shown), the system 100 may not include a dedicated receiver 300. In still other embodiments (not shown), the system 100 may not include a local computer 104. The flexibility of the system should be appreciated in that the smart phone 102, local computer 104 and handheld monitor 300 may not all be desired by the user and therefore the system 100 may be configured to meet the user's needs.

As shown in FIG. 1, the system 100 may include components necessary for connecting the audio and video capture device 200, smart phone 102 and/or local computer 104 and/or dedicated receiver 300 to servers 110 at a remote data center. A user may use a remote computer 112 to connect to the audio and video data received by the servers 110. Thus, a user may access the audio and video data captured by audio and video capture device 200 even if the user does not have access to a smart phone 102, local computer 104 or dedicated receiver 300.

In some embodiments of the invention, the audio and video data may be stored on servers 110 at a remote data center. Thus, the audio and video data is not stored on the user's local computer 104, preventing it from occupying vital hard drive space and minimizing its vulnerability to loss. Users may store the audio and video data, select particular data to be stored and share data through an Internet link.

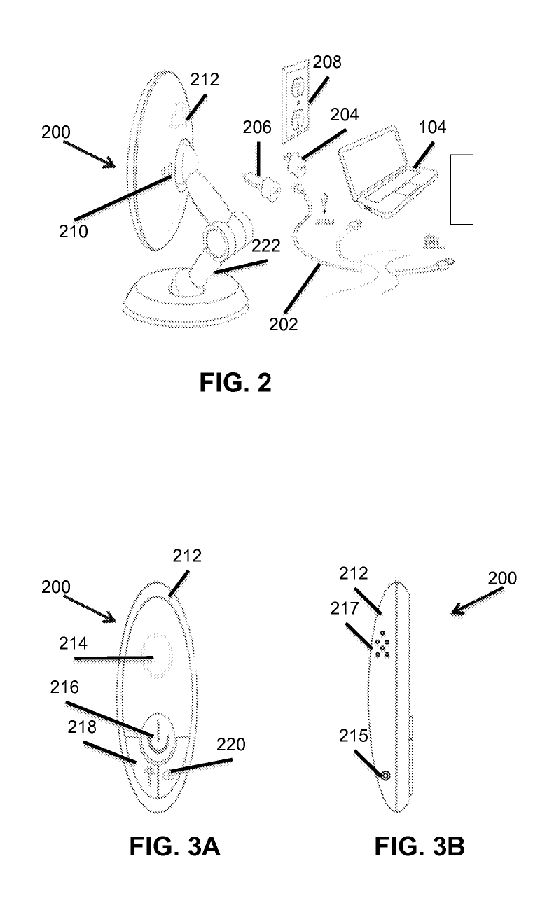

As shown in FIG. 2, systems according to embodiments of the invention include an audio and video capture device 200. As is common with many small electronics, the audio and video capture device 200 can run on AC power. The system 100 can include a power cord 202. Both the device 200 and local computer 104 can be configured to receive power cords 202. The power cords 202 may be connected to the audio and video capture device 200 via usb port 210. The power cord 202 may be connected to an AC power adaptor 204 so that the audio and video capture device 200 can be powered by a standard power outlet 208. Alternatively, the power cord may be connected to a 12 volt DC auto power adaptor 206 if a user desired to use the audio and video capture device 200 in a car. In some embodiments of the invention, the AC power adaptor is connected to the audio and video capture device 200 via a magnetic break away cords. The advantage to this feature is that in the event that the audio and video capture device 200 falls into a baby's crib, the cord will break away from the device 200, reducing the risk of injury due to strangulation.

A rechargeable battery pack (not shown) can also be provided for either or both of the audio and video capture device 200 and the dedicated receiver 500. Alternatively, either or both of the audio and video capture device 200 and the dedicated receiver 300 can be configured to accept standard alkaline or other disposable DC batteries. Use of DC batteries is particularly useful for the dedicated receiver 300, which is likely to be carried about by the user and therefore, unlikely to be connected to the AC power adaptor for recharging.

The audio and video capture device 200 may be connected wirelessly to a local computer. In some embodiments of the invention, the wireless connection may be effected by Bluetooth, Bluetooth 3.0, Wi-Fi, GPS and cellular communications technologies, such as 3 G and 4 G. It should be appreciated any wireless connection method may be used in embodiments of the systems and methods of the invention that is sufficient to transfer audio and video data from the audio and video capture device to the desired receiver.

As shown in FIGS. 3A and 3B, audio and video capture device 200 includes an outer housing 212, a video camera 214 for capturing video data, a microphone 215 for capturing audio data, a speaker 217 for playing sounds, a transmitter (not shown) for transmitting audio and video data, and a receiver (not shown) for receiving directional input to pan, tilt or zoom. The device 200 also includes manual controls. As shown in FIG. 3A, audio and video capture device 200 includes a power control 216 for turning the device 200 on and off; a manual connection control 218 for establishing a manual connection between the audio and video capture device 200 and the desired receiving devices; and a still image control 220 for capturing still images from the video data.

In a preferred embodiment of the invention, the audio and video capture device 200 has high image quality. In the baby-monitoring context, a high image quality is important for monitoring the chest movement of a baby when breathing. In preferred embodiments, chest movements can be detected at a distance of 10 feet. Additionally, it may have a frame rate of greater than 15 frames per second. In preferred embodiments, the resolution is 1080 p or 1920×1080.

In preferred embodiments of the invention, the audio and video capture device 200 includes optical pan, tilt and zoom capacity. It may also include flash memory to store a short period of audio and video on the device 200, such as 30 minutes.

In preferred embodiments of the invention, the audio and video capture device 200 is able to capture images in a darkened room through the use of infrared light emitters, such as IR LED's. The IR emitters can be provided to permit the audio and video capture device 200 to capture images at night or in low ambient light.

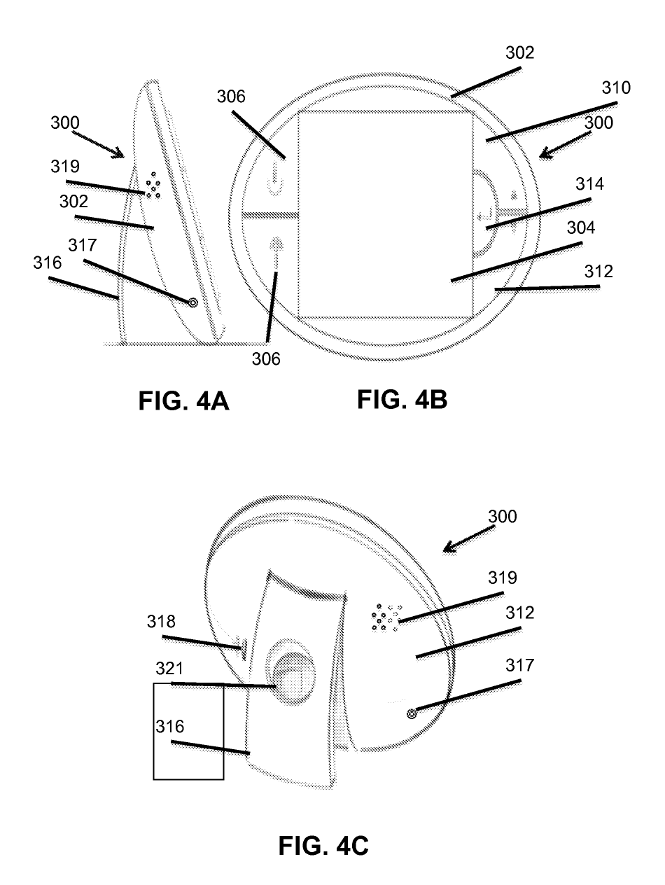

In some embodiments of the invention, as shown in FIGS. 4A-4C, the wireless monitoring system includes a dedicated receiver 300. Dedicated receiver 300 includes a high-resolution display 304 for receiving video data. In preferred embodiments of the invention, the display is an LCD display of at least 960×640 resolution. The dedicated receiver 300 further includes a microphone 317 for capturing audio data and a speaker 319 for receiving audio data.

As shown in FIGS. 4A-4C, in preferred embodiments of the invention, the dedicated receiver 300 may include a belt clip or other attachment device (not shown), such as a tension clip, so that the user may carry it easily. In some embodiments, the tension clip includes a ball that makes a connection to opening 321 on receiver. In other embodiments, the dedicated receiver 300 may include a stand 316 that keeps the dedicated receiver 300 upright so that a user may place the dedicated receiver 300 on a surface and easily view the images received from the audio and video capture device 200. The device 200 also includes manual controls. As shown in FIG. 4B, dedicated receiver 300 includes a power control 306 for turning the device 300 on and off; a manual connection control 308 for establishing a connection between the dedicated receiver 300 and the audio and video capture device 200; volume/scrolling controls 310, 312; and a menu/select control 314.

In preferred embodiments of the invention, a personal electronic device, such as a smart phone may be used a receiver. Such devices come equipped with the display screen, speaker and microphone necessary to use the wireless monitoring system according to embodiments of the invention. Personal electronic devices, such as smart phones, also include the necessary hardware and software to connect wirelessly to the audio and video capture device. For example, smart phones generally are capable of making wireless connection via cellular networks, Bluetooth, or Wi-Fi. Smart phones can be equipped with software to enable the communication between the smart phone and the audio and video capture device. Thus, a user with a smart phone can access the same functions as the dedicated receiver.

It should be understood that fewer or more than one dedicated receiver 300 can be provided with the overall system 100 without departing from the spirit and scope of the invention.

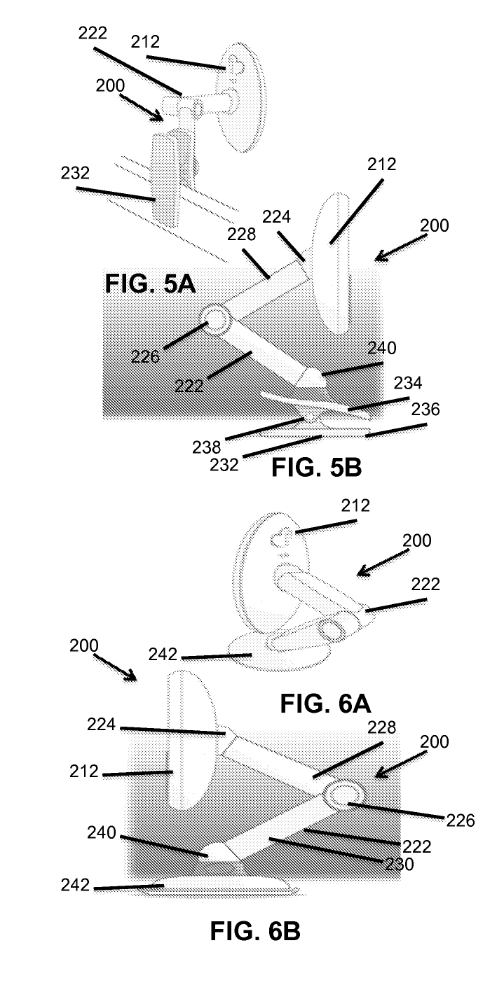

As shown in FIGS. 5A-5B and 6A-6B, the audio and video capture device 200 includes a mounting structure 222 for positioning the audio and video capture device 200 in the desired location. The mounting structure 222 includes an upper arm 228 and a lower arm 230. The upper and lower arms 228, 230 are moveably connected to each with a pivoting hinge 226. This arrangement allows the mounting structure 222 to be adjusted vertically or collapsed for easy storage. Mounting structure 222 is connected to the outer housing 212 with a ball and socket connection 224 for physically positioning the device 200 and aiming at a baby or other subject to be monitored. The mounting structure 222 may include a tension clip 232 to secure the audio and video capture device 200 in a desired area in order to capture the desired audio and video. The tension clip 232 includes an upper and lower clipping members 234, 236 connected via a pivot 238 and spring (not shown). A tension clip 232 provides an easy mounting method for multiple surfaces, including cribs. The mounting structure 222 may be connected to the tension clip 232 with another ball and socket joint 240 to further increase the range of movement. The mounting structure 222 may include a wall bracket (not shown) for stationary mounting.

In other embodiments of the invention, the mounting structure 222 may include a suction cup 242, as shown in FIGS. 6A-6B. A suction cup 242 provides easy mounting for smooth surfaces. The mounting structure 222 may be connected to the suction cup 242 with a ball and socket joint 240 to further increase the range of movement.

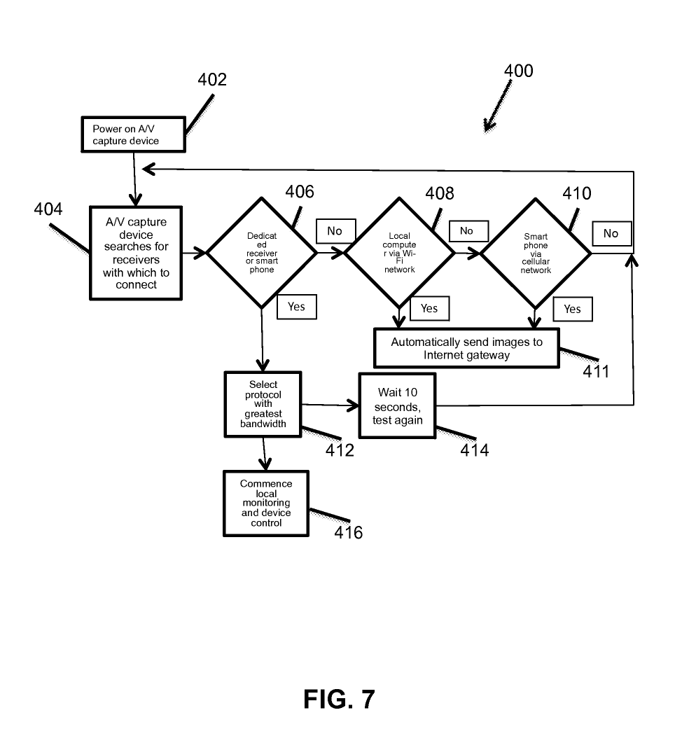

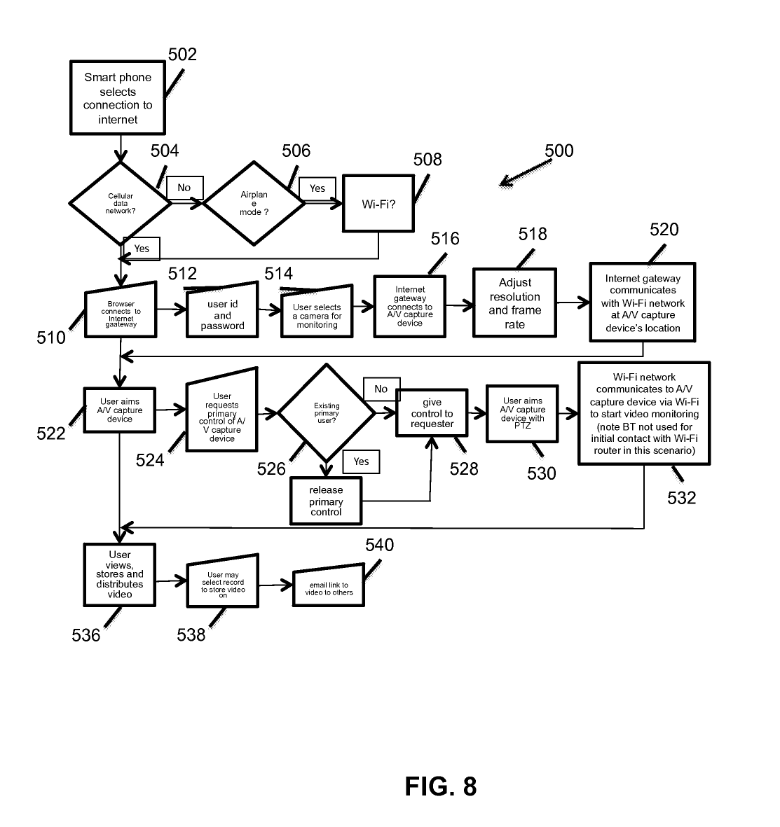

FIG. 7 illustrates a method of automatically making a wireless connection between the audio and video capture device (A/V capture device) 200 and a receiving device, such as a dedicated receiver 300, a smart phone 102 or a local computer 104. As shown in FIG. 7, at step 402, a user powers on the A/V capture device. The A/V capture device 200 searches for devices with which to connect, as shown in step 404. If the A/V capture device 200 does not identify a dedicated receiver 300 in step 406, it searches for a local computer 104. If the A/V device 200 does not identify a local computer 104 in step 408, it searches for a smart phone 102 in step 410. It should be appreciated that the order of the devices for which the A/V device 200 searches can be changed without departing from the scope of the invention. For example, the A/V capture device 200 may search for a dedicated receiver 300, then a smart phone 102, then a local computer 104. If, at steps 406, 408 and 410, the A/V capture device 200 encounters a device, it selects the wireless protocol with the greatest bandwidth and makes a connection via that protocol in step 412. If the A/V capture device 200 does not encounter any device with which to make a connection or if the connection is lost, the A/V capture device 200 waits a period of time, such as 10 seconds, and begins the search again, as shown in step 414. It should be appreciated that the period of time may be adjusted and that longer or shorter periods of time are within the scope of the invention.

Embodiments of the invention include a method 500 of making a wireless connection between the A/V capture device 200 and a smart phone 102 through an Internet gateway. At step 502, a user takes the appropriate action for his particular smart phone to make a connection to an Internet gateway to the A/V capture device 200. As shown at step 504, there is an assessment to determine whether a connection to a cellular carrier data network is available. If it is determined that Wi-Fi connection is not available, there is an assessment to determine whether the smart phone 102 is in “airplane mode” at step 506. If the smart phone 102 is in “airplane mode,” there is an assessment to determine whether a Wi-Fi connection is available at step 508. Via either a data network or a Wi-Fi connection, the user's Internet browser connects to the Internet gateway in step 510.

At step 512, the user's id and password is entered into the Internet gateway. The user selects an A/V capture device 200 (availability is based on devices 200 associated with user's id and password) at step 514 and the Internet gateway connects to the selected A/V capture device 200 at step 516. The user may adjust the resolution and frame rate of the A/V capture device 200 at step 518. At step 520, the Internet gateway communicates with the Wi-Fi network at the location of the A/V capture device 200. At step, 522, the user aims the A/V capture device 200. At step 524, the user may request primary control of the A/V capture device 200. A determination of whether there is an existing primary user is made at step 526. If there is an existing primary user, the primary user may release primary control at step 534. After the primary control is released or if there is not an existing primary user, control is given to the requesting user at step 528. The user then aims the A/V capture device using pan, tilt and zoom controls at step 530. At step 532, the Wi-Fi network communicates to the A/V capture device 200 to start capturing audio and video. The user views, stores and distributes the audio and video at step 536. The user may select to record or store the audio and video at step 538 and/or may email a link to the stored audio and video to others at step 540.

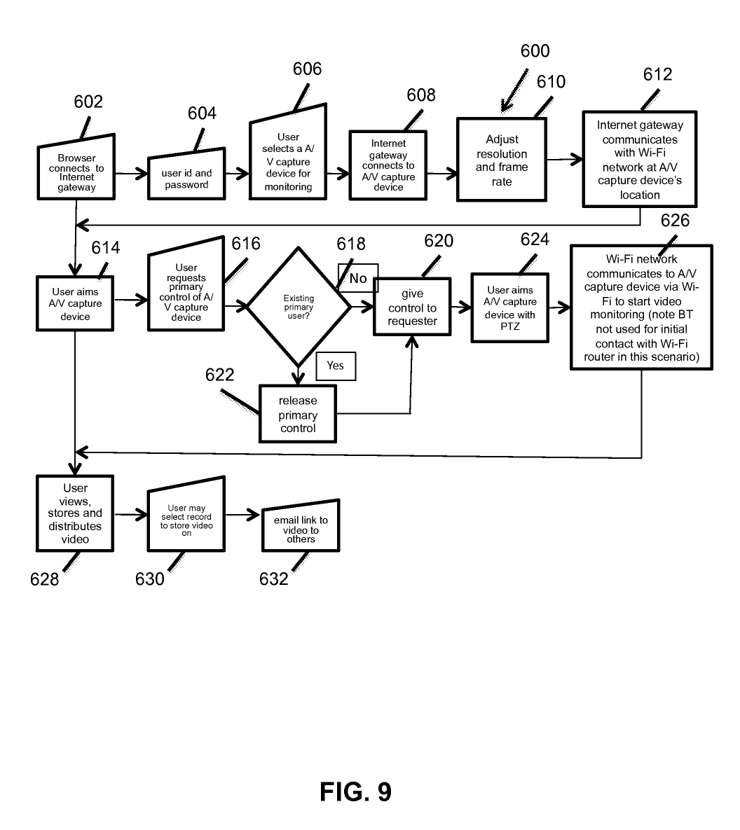

Embodiments of the invention include methods 600 for connecting with a personal computer 104, as shown in FIG. 9. At step 602, the browser of the computer 104 connects to an Internet gateway. At step 604, the user's id and password is entered into the Internet gateway. The user selects an A/V capture device 200 (availability is based on devices 200 associated with user's id and password) at step 606 and the Internet gateway connects to the selected A/V capture device 200 at step 608. The user may adjust the resolution and frame rate of the A/V capture device 200 at step 610. At step 612, the Internet gateway communicates with the Wi-Fi network at the location of the A/V capture device 200. At step 614, the user aims the A/V capture device 200. At step 616, the user may request primary control of the A/V capture device 200. A determination of whether there is an existing primary user is made at step 618. If there is an existing primary user, the primary user may release primary control at step 622. After the primary control is released or if there is not an existing primary user, control is given to the requesting user at step 620. The user then aims the A/V capture device using pan, tilt and zoom controls at step 624. At step 626, the Wi-Fi network communicates to the A/V capture device 200 to start capturing audio and video. The user views, stores and distributes the audio and video at step 628. The user may select record to store the audio and video at step 630 and/or may email a link to the stored audio and video to others at step 632.

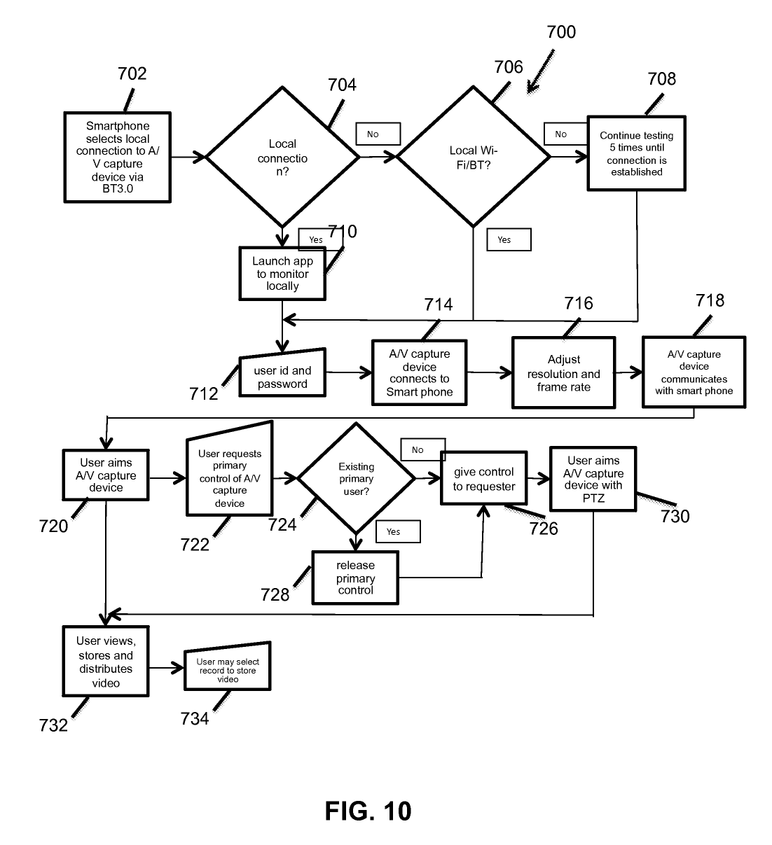

As shown in FIG. 10, embodiments of the invention also include methods of wirelessly connecting the A/V capture device 200 with a smart phone 102. At step 702, the user takes the appropriate action for his particular smart phone 102 to make a local connection, such as Bluetooth or Bluetooth 3.0, to the A/V capture device 200. A determination is made as to the whether a location connection is available in step 704. In step 706, if a local connection is not available, a determination is made as to whether a Wi-Fi connection is available. If neither a local connection or Wi-Fi connection are available, the A/V capture device 200 continues testing for a connection in an effort to launch the local monitoring application in step 708. It should be appreciated that the number of times or the time period that the A/V capture device 200 continues testing may be adjusted and that multiple time periods would be within the scope of the invention.

At step 710, an application is launched on the smart phone 102 if a local connection is available. At step 712, the user's id and password is entered into the application. The A/V capture device 200 connects with the smart phone 102 at step 714. The user may adjust the resolution and frame rate of the A/V capture device 200 at step 716. At step 718, the A/V capture device communicates with the smart phone 102. At step 720, the user aims the A/V capture device 200. At step 722, the user may request primary control of the A/V capture device 200. A determination of whether there is an existing primary user is made at step 724. If there is an existing primary user, the primary user may release primary control at step 728. After the primary control is released or if there is not an existing primary user, control is given to the requesting user at step 726. The user then aims the A/V capture device using pan, tilt and zoom controls at step 730. At step 732, the user views, stores and distributes the audio and video. The user may select record to store the audio and video at step 734. The user may also email a link to the stored audio and video to others. The user can also authenticate other users to log in and view images, if the user has administrator privileges.

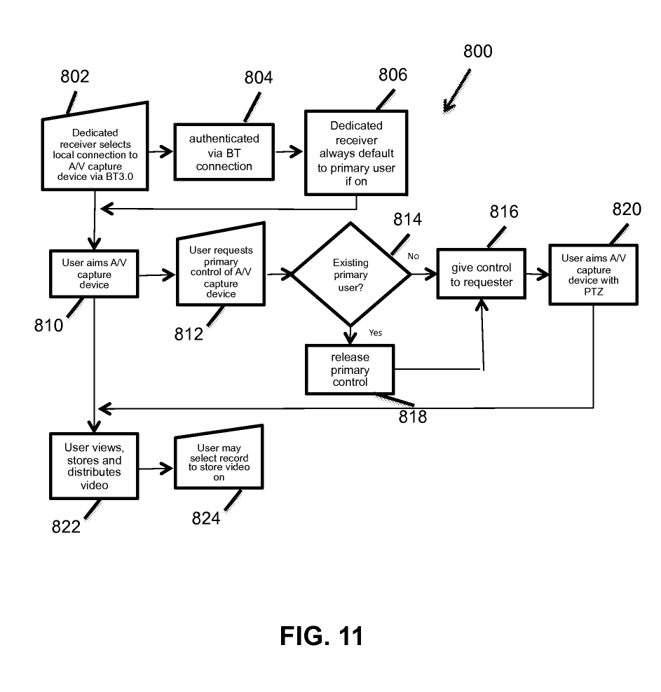

As shown in FIG. 11, embodiments of the invention include methods of wirelessly connecting an A/V capture device 200 with a dedicated receiver 300. In step 802, a user selects to initiate a local connection to the A/V capture device 200 via Bluetooth 3.0. The connection is authenticated via Bluetooth 3.0 at step 804. At step 806, the dedicated receiver 300 is identified as the primary user. This is the default setting if the dedicated receiver 300 is connected to the A/V capture device 200. Alternatively, the user may create a setting in which the audio and video data is sent to the remote servers 110 for storage even if a local connection is used. Once the dedicated receiver 300 is connected to the A/V capture device 200, the user aims the A/V capture device 200 at step 810. At step 812, the user may request primary control of the A/V capture device 200. A determination of whether there is an existing primary user is made at step 814. If there is an existing primary user, the primary user is notified that they have released primary control at step 818. After the primary control is released or if there is not an existing primary user, control is given to the requesting user at step 816. The user then aims the A/V capture device using pan, tilt and zoom controls at step 820. At step 822, the user views, stores and distributes the audio and video. The user may select record to store the audio and video at step 824. The user may also email a link to the stored audio and video to others. The user can also authenticate other users to log in and view images, if the user has administrator privileges.

The foregoing description is provided for describing various embodiments and structures relating to the invention. Various modifications, additions and deletions may be made to these embodiments and/or structures without departing from the scope and spirit of the invention.

What is claimed is:

1. A wireless monitoring system comprising:
(a) At least one audio and video capture device having a video camera, a microphone, a speaker, a transmitter for transmitting audio and video data, and a receiver for receiving directional input to pan, tilt or zoom;
(b) At least one receiving device for receiving audio and video data, wherein the receiving device includes a screen for displaying the video data, a speaker for emitting the sound data, a microphone to transmit audio data from a user to the audio and video capture device, and communication circuitry operable to: identify and effect a wireless transmission connection with the greatest available bandwidth; transmit directional instructions to pan, tilt or zoom from the user to the audio and video capture device; and transmit instructions from the user to the audio and video capture device to save still photographs or portions of video from the video data; and
(c) A mounting device for removably mounting the audio and video capture device in a location.

2. The wireless monitoring system of claim 1, wherein the mounting device comprises at least one ball and socket structure for positioning the audio and video capture device.

3. The wireless monitoring system of claim 1, wherein the mounting device comprises a tension clip.

4. The wireless monitoring system of claim 1, wherein the mounting device comprises a suction cup.

5. The wireless monitoring system of claim 1, further comprising multiple receiving devices for receiving audio and video data, wherein the audio and video data may be received by multiple receiving devices simultaneously.

6. The wireless monitoring system of claim 1, wherein the audio and video data is transmitted from the audio and video capture device to the at least one receiving device via one of the following wireless protocols: Bluetooth, Wi-Fi, and a combination of Bluetooth and Wi-Fi.

7. The wireless monitoring system of claim 1, wherein the at least one receiving device is bi-direction and can control the pan, zoom and tilt of the audio and video capture device.

8. The wireless monitoring system of claim 1, wherein the at least one receiving device is a portable electronic device.

9. The wireless monitoring system of claim 1, wherein the at least one receiving device is a computer.

10. The wireless monitoring system of claim 1, further comprising infrared emitters that allow the audio and video capture device to capture images in low ambient lighting.

11. The wireless monitoring system of claim 1, wherein the at least one receiving device receives audio and video data from multiple audio and video capture devices.

12. The wireless monitoring system of claim 8, wherein the portable electronic device comprises: an input component operable to receive audio and video data from the audio and video capture device; and communication circuitry operable to: transmit audio data from a user to the audio and video capture device; transmit directional instructions to pan, tilt or zoom from the user to the audio and video capture device; and transmit instructions from the user to the audio and video capture device to save still photographs or portions of video from the video data;

13. The wireless monitoring system of claim 12, wherein the portable electronic device includes circuitry to function as a cellular phone and to simultaneously maintain a cellular phone call and the wireless monitoring functions.

14. The wireless monitoring system of claim 12, wherein the portable electronic device includes circuitry to function as a cellular phone and to automatically resume monitoring in the event that a phone call interrupts the monitoring session.

15. A wireless monitoring system comprising:
(a) A audio and video capture device having a video camera, a microphone, a speaker, a transmitter for transmitting audio and video data, a receiver for receiving directional input to pan, tilt or zoom, and infrared emitters that allow the audio and video capture device to capture images in low ambient lighting;
(b) A mounting device for removably mounting the audio and video capture device in a location, wherein the mounting device comprises a ball and socket structure for aiming the audio and video capture device;
(c) At least one receiving device for receiving audio and video data, wherein the receiving device includes a screen for displaying the video data, a speaker for emitting the sound data, a microphone to transmit audio data from a user to the audio and video capture device, and communication circuitry operable to: identify and effect a wireless transmission connection with the greatest available bandwidth; transmit directional instructions to pan, tilt or zoom from the user to the audio and video capture device; and transmit instructions from the user to the audio and video capture device to save still photographs or portions of video from the video data;
(d) A portable electronic device for interfacing with the audio and video capture device, the portable electronic device comprising: an input component operable to receive audio and video data from the audio and video capture device; and communication circuitry operable to: transmit audio data from a user to the audio and video capture device; transmit directional instructions to pan, tilt or zoom from the user to the audio and video capture device; and transmit instructions from the user to the audio and video capture device to save still photographs or portions of video from the video data;
wherein the audio and video data is transmitted from the audio and video capture device to the at least one receiving device via one of the following wireless protocols: Bluetooth, Wi-Fi, and a combination of Bluetooth and Wi-Fi;
wherein the portable electronic device includes circuitry to function as a cellular phone and to simultaneously maintain a cellular phone call and the wireless monitoring functions.

16. A method for wirelessly monitoring an area, the method comprising:
(a) Providing power to an audio and video capture device;
(b) Searching by the audio and video capture device for a receiver to connect with;
(c) Identifying and selecting an available wireless protocol with the greatest bandwidth available;
(d) Connecting the audio and video capture device with the receiver via the available wireless protocol with the greatest bandwidth available;
(e) Adjusting the pan, tilt and zoom of the audio and video capture device with the receiver; and
(f) Receiving audio and video data on the receiver.

17. The method of claim 16, further comprising:
(g) Storing the audio and video data on a server in a remote data center; and
(h) Recalling the stored audio and video data at a later time.

18. The method of claim 16, wherein the wireless protocol is one of the following wireless protocols: Bluetooth, Wi-Fi, and a combination of Bluetooth and Wi-Fi.

19. The method of claim 16, wherein the audio and video capture device is connected to the receiver via a server in a remote data center and further comprising the steps of:
(g) verifying a user's identification and password before making the remote connection;
(h) receiving input from the user regarding the desired audio and video capture device from which to receive data;
(i) Adjusting the resolution and frame rate of the audio and video capture device to match the available bandwidth on the selected wireless connection; and
(j) Starting the transmission of data from the audio and video capture device to the receiver.

20. The method of claim 19, further comprising:
(k) Storing the audio and video data on a server in a remote data center; and
(l) Recalling the stored audio and video data at a later time.

21. The method of claim 19, wherein is one of the following wireless protocols: Bluetooth, Wi-Fi, and a combination of Bluetooth and Wi-Fi.
